(19) United States
(12) Patent Application Publication
(10) Pub. No.: US 2014/0270799 A1
(43) Pub. Date: Sep. 18, 2014

(54) METHOD AND SYSTEM FOR CAMERA ENABLED ERROR DETECTION

(71) Applicants: Richard D. Roberts, Hillsboro, OR (US); Selvakumar Panneer, Hillsboro, OR (US)

(72) Inventors: Richard D. Roberts, Hillsboro, OR (US); Selvakumar Panneer, Hillsboro, OR (US)

(21) Appl. No.: 14/210,390

(22) Filed: Mar. 13, 2014

Related U.S. Application Data
(60) Provisional application No. 61/779,426, filed on Mar. 13, 2013.

(51) Int. Cl. H04B 10/116

(52) U.S. Cl. CPC H04B 10/116
USPC 398/130

(57) ABSTRACT

The disclosure generally relates to a method and apparatus for decoding optical signals form a device. An exemplary method includes the steps of receiving, at a device, a plurality of optical frames, each optical frame having an encoded optical signal with an optical signal frequency; recording the plurality of optical frames to obtain a recorded optical image, the recorded optical image having a first frame per second (FPS) recording rate; processing the recorded optical image to obtain a digital signal corresponding to the encoded optical signal contained in at least one of the plurality of optical frames; and decoding the digital signal to obtain decoded information.

The instant application claims priority to Provisional Application No. 61/779,426, filed Mar. 13, 2013. The application also relates to patent application Ser. No. 13/359,351, filed Jun. 30, 2012; patent application Ser. No. 13/630,066, filed Sep. 28, 201; PCT Application No. PCT/US2013/46224, filed Jun. 18, 2013; PCT Application No. PCT/US2011/60578 filed Nov. 14, 2011; and PCT Application No. PCT/US2011/054441, filed Sep. 30, 2011. The recitation of each of the aforementioned applications is incorporated herein in its entirety.

### BACKGROUND

1. Field

The disclosure relates to a method and system for camera enabled error detection. Specifically, the disclosure relates to methods, systems and apparatus for receiving and decoding optical error codes from unsophisticated appliances.

2. Description of Related Art

Error communication for devices lacking peripheral display is conventionally through beeping or other forms of audio alarms. When the device is incapable of continuing normal operation, the operator is alerted by a continuous or discrete beeps. The operator must then discern the cause of the error and reset the device. One such example is the error code generated during a motherboard initialization and prior to having any peripheral connections. Here, the motherboard either beeps or displays a multi-segment Light Emitting Diode (LED) to alert the operator to the error.

The beep code detection is awkward because it requires carefully counting the number of beeps and the beep duration(s). For a conventional motherboard a table of beep codes includes 16 different beep codes, including, one beep to denote DRAM refresh failure, two beeps to denote parity circuit failure; three beeps to denote base 64K RAM failure, etc. To this end, beep codes have a limited number of codes to avoid being overly complicated. Segment codes are equally unfriendly because conventional dual 7 segment displays provides 256 different codes, requiring the operator to manually index a lookup table to discern the code meaning.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 schematically illustrates an implementation of the disclosure;

FIG. 2 illustrates optical signal modulation according to one embodiment of the disclosure;

FIG. 3 is a flow diagram for implementing an embodiment of the disclosure;

FIG. 4 illustrates an exemplary system according to one embodiment of the disclosure;

FIG. 5 shows an exemplary image sensor for converting an optical signal;

FIG. 6 shows an exemplary sampling technique according to one embodiment of the disclosure;

FIG. 7 shows an exemplary method for implementing start frame delimiter according to one embodiment of the disclosure;

FIG. 8 illustrates a data frame according to one embodiment of the disclosure; and

FIG. 9 illustrate sampling error where the light receiving device is out of phase with the light transmitting device.

### DETAILED DESCRIPTION

The disclosed embodiments generally relate to communicating data by varying a frequency of an amplitude modulated electromagnetic radiation or light signal. Embodiments may comprise logic such as hardware and/or code to vary a frequency of an amplitude-modulated light source, such as a visible light source, an infrared light source, or an ultraviolet light source. For instance, a visible light source such as a light emitting diode (LED) may provide light for a room in a commercial or residential building. The LED may be amplitude modulated by imposing a duty cycle that turns the LED on and off. In some embodiments, the LED may be amplitude modulated to offer the ability to adjust the perceivable brightness, or intensity, of the light emitted from the LED. Embodiments may receive a data signal and adjust the frequency of the light emitted from the LED to communicate the data signal via optical or light signals. The data signal may be communicated via the light source at amplitude modulating frequencies such that the resulting flicker is not perceivable to the human eye.

In one embodiment of the disclosure, the error codes of an apparatus are transmitted in short messages in the form of LED signals to a recipient decoding device. In an exemplary embodiment, a unit without peripheral communication means (e.g., a distressed device) signals a receiver. The receiver may record the incoming signal or may convert the incoming signal to a digital signal in real time. The converted signal can then be used to decode the message form the apparatus. The exemplary embodiments can be applied to motherboard initial power-up, external disk drive failure, blade server status inquiry or automotive error codes.

In another embodiment, the, disclosure relates to the use if LEDs for sending information on error codes. The information is include device identifier and/or location. The error codes can be in the form of short messages. Some embodiments encompass the sending of error codes from a distressed device. Examples of devices without peripheral means for communication include: initial power up messages via on-board LEDs on a motherboard, external disk drive failures via the front panel LED of a Universal Serial Bus (USB) external disk drive, blade server status information via front panel LEDs, and automobile error codes via various lights such as the check engine light. The blinking light (e.g., LED) alerts users that something is wrong, white also repetitively sending an optical error message. According to embodiments, a receiver for error messages from an LED may be a camera, such as a camera on a mobile device, for example a Smartphone camera. The camera may record a short video of the blinking light and may perform post-image processing to extract a transmitted message according to the disclosed embodiments.

Table 1 shows an exemplary motherboard error communication code. The errors are displayed in sound bursts or beeps. The human operator must discern the number of beeps and consult a manual to determine the meaning of the error code. Beep codes are awkward as they require carefully monitoring of the number of beeps and duration.

TABLE 1
Beep Error Codes

| Beep Code | Meaning |
|---|---|
| 1 Beep | DRAM refresh failure |
| 2 Beeps | Parity circuit failure |
| 3 Beeps | Base 64K RAM failure |
| 4 Beeps | System timer failure |
| 5 Beeps | Processor failure |
| 6 Beeps | Keyboard controller/gate A20 failure |
| 7 Beeps | Virtual mode exception error |
| 8 Beeps | Display memory read/write failure |
| 9 Beeps | ROM BIOS checksum failure |
| 10 Beeps | CMOS shutdown register read/write error |
| 11 Beeps | Cache memory error |
| Continuous Beeping | Memory or video problem |
| 1 Long Beep | Memory problem |
| 1 Long, then | Video error |
| two Short Beeps | |
| 1 Long, then | Video error |
| three Short Beeps | |

Certain devices display the error code in a hexadecimal display. Such devices display a two-digit code (e.g., 08) that must be manually searched to identify the cause of the error. The disclosed embodiments also obviate the need for a human to manually read hexadecimal displays of error codes and determine the cause.

FIG. 1 schematically illustrates an implementation of the disclosure. Specifically, FIG. 1 illustrates a motherboard 110, having LEDs 105 which can be used to signal messages during the initial power-up or during the normal life of the motherboard. Smart device 110 receives signals 107 from motherboard 105. Signal 107 can be an LED signal. Signal 107 can contain simple diagnostic messages in the form of modulating light. Smart device 110 receives and displays 115 the signal. Smart device 110 can also record the incoming signal for future display.

In an embodiment, smart device 110 can be configured to convert optical signal 107 to digital signal (not shown). The digital signal can be decoded to display a natural language message to the operator. The natural language message can be formatted by the manufacturer to identify system fault or any other communication intended for the operator. It should be noted that motherboard 100 is non-limiting and exemplary.

FIG. 2 illustrates optical signal modulation according to one embodiment of the disclosure. At FIG. 2, apparatus 210 is a distressed device communicates via optical signals 220. Optical signals 220 can be transmitted by an optical source, such as LED, at device 210. Optical signal 220 can be transmitted as frames 215. Each of optical frames 215 can include optical signal of varying frequency 217. The optical signals having varying frequency can contain a message encoded therein. Each optical frame can have a constant or a varying optical frequency 217. Further, each optical frame 215 can have a substantially similar or different optical frequency from oilier optical frames. Device 240 receives optical frames 215. Optical frames 215 can be converted to digital signal (not shown) at device 240. Digital signals (not shown) may be decoded to natural language messages and displayed to the operator.

Optical frames 215 may also be stored at device 240 for future reference and decoding. Optical frames 215 can be recorded at a desired incoming frame rate per second (FPS). The FPS cane be similar to, or different from, transmission frame rate 245. In one embodiment of the disclosure, the FPS is selected such that the optical signal display can be detected by human eye (i.e., less than 30 FPS).

FIG. 3 is a flow diagram for implementing an embodiment of the disclosure. The process of FIG. 3 starts at steps 310 when a device capable of optical signal reception receives optical data. The optical data can be transmitted in frames having a frame rate. The device can record the received data. The optical data can be transmitted from any device having light transmission capability. At step 320, the optical data is converted to digital data. The optical data and the digital signal may optionally be recorded for future use. At step, 330 the digital data is decoded. The data may be decoded according to the device manufacturer's decoding scheme. At step 340, the decoded data can be displayed to the operator.

According to one embodiment of the disclosure, optical signals, or frames containing the signals, can be received by any device having one or more optical train in communication with a memory and a processor for receiving, retaining and processing the optical information. In an exemplary embodiment, a smartphone, a camera, an ultrabook™, a laptop or other such devices can be used. The devices can also process received or recorded optical data into digital data suitable for communication.

FIG. 4 illustrates an exemplary system according to one embodiment of the disclosure. In FIG. 4, optical code emitter 400 can be any device capable of modulating and transmitting optical signals. The device emitting the optical signal can be a device under distress. The optical signals can comprise light in the visible frequency range. The optical signal can be optionally processed through lens 410 or an optical train (not shown). The lens or the optical train may be part of the receiving device 402.

Device 402 may also include images sensor 420, recorder 430, image processor 440, digital decoder 450, radio 470, antenna 480 and display 460. The radio and antenna can communicate with the processor and direct outgoing radio signals. Device 402 may also be a part of a wireless network thereby communicating with external servers.

In one embodiment, device 402 may process incoming optical signals to determine the frequency modulations and associate the frequency modulations with the identification numbers for a number of the light sources. In an exemplary embodiment, device 402 may transmit the identification numbers (not shown) relating to the distressed device to a server (not shown) via a network link. In response, device 402 may receive an indication of the location, such as a 3D location map, of the distressed device and/or the location of the particular item communicating the signal. The server (not shown) may also help decode the signal.

Receiving device 402 may include image sensor 420 (i.e., light detector). The image sensor may additionally comprises a demodulator (e.g., FSK demodulator) to receive and interpret the frequency-modulated light from the fight source. Alternatively, demodulator may be part of image processor 440. The receiving device can demodulate the incoming signal by sampling, under-sampling or over-sampling the incoming optical signal.

The image sensor alone, or in cooperation with image processor 440, may convert the incoming optical signals into an electrical signal, such as a pixel of an image representative of the light or a current of a photo diode. For example, the image sensor may comprise a CMOS array or an array of photo detectors. Image sensor 420 detector may capture an image of incoming light (and optionally the light source) and may record at recorder 430. Recorder 430 may comprise storage logic to store the optical images to a storage medium such as dynamic random access memory (DRAM), a flash memory module, a hard disk drive, a solid-state drive such as a flash drive or the like.

Image sensor 420 and/or image processor 440 may comprise sampling logic to determine samples of the light captured by the light detector. For example, the sample logic may identify pixels from the image associated with light sources to identify the light sources and may determine the state of the identified light sources, i.e., whether the image indicates that a light source is emitting light (the light source is on) or the light source is not emitting light (the light source is off). In some embodiments, the sample logic may assign a value to a light source in the on state such as a value of one (1) and a value of a light source in the off state such as a negative one (−1). In such embodiments, the samples may include a value as well as a time indication.

Recorder 430 may capture images at a sampling frequency (FS). The sampling frequency may be a limitation of receiving device 402 in some embodiments or may be a setting of the receiving device in other embodiments. In further embodiments, another signal or user notification may indicate the sampling frequency for which the FSK modulator is configured and the receiving device may adjust the sampling frequency of the light detector to match that sampling frequency either automatically or with some interaction with the user.

The image sensor and/or the image processor may sample or capture samples of the frequency-modulated incoming light at the sampling frequency, under-sampling the transmitted signal via the frequency-modulated light. This process of under-sampling effectively aliases the signal transmitted via the frequency-modulated light to a lower frequency. Since the first frequency is an integer multiple of the sampling frequency, which is a harmonic or overtone of the sampling, frequency, the sample logic captures samples of the first frequency that appear to be at a frequency that is at zero Hz and samples of the second frequency that appear to be at a frequency that is half of the sampling frequency. The sampled signal can be demodulated at an appropriate demodulator (e.g. FSK demodulator).

In an exemplary embodiment, the incoming optical signal may contain location information which can be used to identify and locate the distressed device. The location information may be used to send repair technicians or remotely attend to the distressed device, for example, by remote programming.

In an embodiment where the incoming optical signal is recorded at recorder 430, the image processor may later retrieve and sample the stored image. The sampling can be one by image processor 440 or can be done at image sensor 420. The sampling may comprise sampling each of the plurality of recorded frames (images) sequentially or insequentially. Each frame can be sampled independent of other image frames at a constant or varying sampling rate. The image processor then converts the optical signal to digital data stream and communicates the digital data to digital decoder 450. While the digital decoder is shown as part of device 402, the decoder may be part of an external device. For example, the decoder may be part of an external server or define a cloud-based decoder. Decoder 450 may include one or more processor circuits (not shown) in combination with one or more memory circuits (not shown). Decoder 450 may comprise instructions for decoding the incoming signal to identify the issues communicated by the distressed device through optical code emitter 400. Once decoded, the information can be communicated through display 460 through radio transmission or by any other conventional means.

In one embodiment, the disclosure provides for encoding bits using Direct Current (DC) balanced differential encoding called under-sampled frequency shift. This modulation scheme is similar to frequency shift keying (FSK) inasmuch as there are defined mark and space ON-OFF keying frequencies for encoding bits. The mark (logic 1) and space (logic 0) frequencies may be selected such that, when under-sampled by a low frame rate camera, the mark/space frequencies alias to low pass frequencies that can then be farther processed to decode the bit values.

FIG. 5 shows an exemplary image sensor for converting an optical signal. Specifically, the image sensor of FIG. 5 can convert a two-dimensional light wave (optical signal) to a digital signal. In FIG. 5, the pixel photodetector 510 produces a signal proportional to the incoming integrated light intensity (not shown), which is then held at the integrate and hold processor 520, for the scanning ADC 530, thus establishing the frame rate of the video camera. While photodetectors can have hundreds of kHz of bandwidth, the scanning process may set a low sample rate (e.g., 30 FPS). Pixel demodulation can be done at Demux 540 to provide pixel numeric amplitude value.

The relationship between the frame rate of the camera and the mark and space OOK (ON-OFF keying) frequencies can be derived by temporarily representing the OOK frequency as a sinusoidal at frequency ω_{OOK} with a random phase θ_{OOK}. A simplified model of sampling using the Fourier series representation of the Dirac comb sampling fraction (Dirac comb sampling function can he a series of time periodic impulses similar to a camera's shutter clicks) can be introduced as Equation (1) below:

$${\sum }_{k = - ∞}^{∞} δ ( t - kT ) = \frac{1}{T} {\sum }_{k = - ∞}^{∞} {e}^{i 2 π kt / T} = \frac{1}{T} {\sum }_{k = - ∞}^{∞} {e}^{i k {ω}_{S} t} \qquad Eq . ( 1 )$$

In Equation (1), ω_{S} is the sampling frequency and k is an integer. The OOK frequency is expressed as a harmonic of the sampling frequency (i.e. ω_{OOK}>ω_{S}) plus a frequency offset term ω_{OOK}=nω_{S}±ω_{Δ} where ω_{Δ}≦|ω_{S}/2|. In one embodiment, the is no attempt to synchronize the camera frame rate with the transmitter bit rate clock; hence, there can be a finite frequency offset term. The sampled OOK waveform can be approximated by the multiplication of the sampling function with the OOK frequency waveform and then integrated (low pass filtered) by the image sensors integrate and hold circuit 520, establishing a low frequency output beat frequency as shown in Equation (2):

$$Re \{ sin ( {ω}_{OOK} t + {θ}_{OOK} ) \cdot \frac{1}{T} {\sum }_{k = - ∞}^{∞} {e}^{i k {ω}_{S} t} \} = sin ( n {ω}_{S} + {ω}_{Δ} + {θ}_{OOK} ) t \cdot \frac{1}{T} {\sum }_{k = - ∞}^{∞} cos ( k {ω}_{S} t ) ∝ sin ( {ω}_{Δ} t + {θ}_{OOK} )$$

The resulting low frequency waveform can then be passed through a hard limber to reestablish the OOK square waveform. The term sin(ω_{Δ}t+θ_{OOK}) is the subsampled aliased term as shown in Eq. (3).

sin(ω_{Δ}t+θ_{OOK})→x(t,ω_{Δ})=sgn[sin(ω_{Δ}t+θ_{OOK})] Eq. (3)

The low frequency signal x(t,ω_{Δ}) is a function of the frequency offset and the initial phase of the OOK signal. The frequency offset term may give rise to the need for forward error correction compensation. In one embodiment where it is assumed that the frequency offset has one of two values taken from the set {0±ω_{S}/2}. The term θ_{OOK} can be significant in that it sets the phase of the low frequency signal x(t,ω_{Δ}).

In one embodiment, ω_{Δ}=0 defines the UFSOOK space frequency(logic 0) as a harmonic of the sampling frequency; that is, a as an integer. Likewise, let ω_{Δ}=±ω_{S}/2 define the UFSOOK mark frequency (logic 1) as a harmonic of the sampling frequency plus a ±½ fractional offset. For example, if the camera has a frame rate of 30 FPS, n=1 and the offset frequency is 15 Hz, then the space frequency is 30 Hz and the mark frequency could be 15 Hz.

Next, the sampling rate and the sub-sampled aliased waveform x(t, ω_{S}) for the two cases are considered for bit decisions. Given the assumption that ω_{Δ}=0, then when the UFSOOK space frequency is being received, x(t, ω_{Δ})=sgn[sin(θ_{OOK})] which means the observed value is solely dependent upon the initial phase of the space waveform.

Regardless of the initial value of the space frequency waveform phase, the aliased value is short time invariant; that is, the same aliased value is observed every time a sample is taken. It is noted that the clocks (distressed device and the light receiving device) arc not synchronized and the phase term can slowly drift. Thus, at the output of the sub-sampling detector (i.e. camera), observing the same value on subsequent samples indicates that a logic zero is being sent. Likewise, if a UFSOOK mark frequency is being received then

$$x ( t , {ω}_{Δ} ) = sgn [ sin ( \frac{{ω}_{S}}{2} t + {θ}_{OOK} ) ] \qquad Eq . ( 4 )$$

which, for the given example results in a 15 Hz waveform toggling every sample (high and low). Thus, if a subsampled output can be observed that is toggling at one-half the video frame rate then a logic 1 is being transmitted.

FIG. 6 shows an exemplary sampling technique according to one embodiment of the disclosure. In particular, FIG. 6 provides a practical representation of how bits may be sent via blinking lights. In FIG. 6 logic 1 is represented by waveforms 610 and 612; logic 0 is represented by waveforms 614 and 616. Each of the waveforms 610, 612, 614 and 616 is sampled by sampling points 620, 622, 624 and 626, respectively. It can be readily seen from FIG. 6 that the waveform of logic has a different frequency than the waveform of logic 0. The sampling occurs at regular intervals.

Specifically, logic 1 is transmitted as one cycle of 15 Hz OOK (the curve shown between 0/ and 2/frames per second (0/FPS and 2/FPS)), and a logic 0 is transmitted as two cycles of 30 Hz OOK (the curve shown between 2/FPS and 4/FPS). Therefore, FIG. 6 shows bit pattern “1 0”. The OOK waveform of FIG. 6 shown is sampled 30 times per second by a camera, as represented by the upward pointing arrows 620, 622, 624 and 626. Two samples per bit are shown making the bit rate half of the sample rate (i.e. the camera frame rate).

For logic 1, the two samples differ in value (light on and light off). For logic 0, the two samples have the same value (light on). The video frame-to-video frame decoding rules may be summarized b Equation 5 below:

$$x ( t , {ω}_{Δ} ) = \{ \begin{matrix}unchanging & { }^{``} {0}^{″} \\ toggling & {}_{}^{``}{1}{}_{}^{″}\end{matrix} \qquad Eq . ( 5 )$$

In an exemplary embodiment, once decoding rules are set data frames rates can be created. This may be done by defining a start frame delimiter (SFD) appended to the beginning of each data frame. The end of the frame may be indicated by the second appearance of the SFD, which would imply the beginning of the next data frame. The SFD helps overcome synchronicity between the light emitting deice and the light receiving device.

FIG. 7 shows an exemplary method for implementing SFD according to one embodiment of the disclosure. As shown in FIG. 7, the SFD may be four video frames long (710, 720, 730 and 740). The first two video frames (710 and 720), or first ½ of the SFD, concern the use of high frequency OOK transmitted such that the camera sees the light as being ½ ON and ½ OFF. The second part of the SFD, for the next two video frames (730, 740), includes an OOK logic 1 signaling to determine if the clocks for the LED transmissions and for the camera image sensor are in sync enough to allow further processing. If a logic 1 is not detected at the image sensor, then the process may be restarted. In one embodiment, frames 710, 720, 730 and 740 are formed using light of fractional intensity.

The SFD, which may for example be two bit times long (i.e., four video frames), may be sent prior to a normal data frame. It is noted that although bits are referenced in the embodiment of FIG. 7, they are actually merely bursts of high frequency OOK that last for two bit time frames. Any frequency OOK above several KHz may suffice according to embodiments. In an exemplary implementation, a switching frequency of approximately 25 KHz was used.

In the above two bit scenario, the first bit of the SFD may be sent at an OOK frequency that cannot be followed by a normal Smartphone grade image sensor. The pixel integrator in the image sensor may extract the average light intensity such that, in the image frames associated with the first bit of the SFD, the light appears half ON (assuming a 50% duty cycle). The half ON condition can persist for one bit time and may signal the beginning of the frame. The next bit of the SFD is the transmission of the logic 1 mark OOK frequency. If, during the processing of the SFD, logic 1 is not observed (e.g., logic 0 is observed instead), it can be concluded that something is wrong and the frame should be discarded. The rest of the data frames having logic ones and zeros can follow the SFD as presented by transmission of the appropriate mark or space OOK frequency. Each bit can have a duration of two video frames as required by the differential code as set forth in Equation (4) above.

According to an embodiment of the disclosure, processing of the data frame can be performed in real-time or non-real time. In an implementation, repetitive data frames were sent and then recorded as a video of the lights for the prescribed number of video frames commensurate with the length of the data frame. In non-real time, the video was post-processed for the salient light features. Real-time processing may involve determining the state of the incoming light on a per image basis, rather than after the entire recording is completed.

According to an embodiment, in order to allow processing of a data frame, the receiving device first looks for the SFD initial two video frames (lights half ON) in the received frames. Thereafter the data frames can be unwrapped by linearly reordering the recorded frames with respect to the initial SFD frames. Thus, the SFD marks the beginning of the data frame for further processing.

FIG. 8 illustrates a data frame according to one embodiment of the disclosure. In the data frame of FIG. 8, the SFD frame is followed by bits 1-10. Here, logic 0 can be two video frames of OOK at frequency n*F_{fps}, and logic 1 can be two video frames of OOK at frequency (n±0.5)*F_{fps}; where n is the harmonic relation or the sampling rate between the light receiving device (e.g., camera) frame rate (fps) and the on/off frequency (e.g., n>1) and F is the camera frame rate per second (fps).

In an exemplary embodiment, a 50% duty cycle was used with the UFSOOK modulation. OOK is a form of AM modulation. For a 50% duty cycle the most energy is in the data bit sidehands. That is, the most energy per bit is in the sideband. As the duty cycle varies from 50% duty cycle (either increasing, or decreasing) the energy per bit decreases because either the total power is decreasing or more energy is transferring to the light wave carrier.

In an embodiment, access to the error codes may need to be limited/controlled, for example, to prevent unauthorized persons access to proprietary status information. Such situations may arise for example in a server room with status LEDs mounted on the front panel.

In one embodiment, access is limited through unencrypted data transmission with encrypted access to the database lookup table. Here, a user may download the data transmission, but cannot translate the received code to an error message without first entering an access code in the receiver device. The access code can be a password and the receiver device can be a Smartphone. An application program can be associated with the environment in question to ensure security. For example, the required passwords may be periodically updated over a wireless network to curb unauthorized access.

In another embodiment, access is limited through data encryption at the transmitter with decryption at the receiver. Here, the data itself is actually encrypted, for example by being scrambled by XOR'ing with a secret bit pattern key. The scrambled code can be then transmitted over the LED lights, received by the image sensor, and processed by the receiver. The descrambling may be achieved by an application on the receiver, may be associated with a particular location or by using a preloaded key.

FIG. 9 schematically represents an exemplary apparatus according to one embodiment of the disclosure. Specifically, FIG. 9 shows device 900 which can be an integral part of a larger system or can be a stand-alone unit. For example, device 900 can define a system on chip configured to implement the disclosed methods. Device 900 may also be part of a larger system having multiple antennas, a radio and a memory system. Device 900 may be define a software or an applet (APP) running on a processor. In one embodiment, device 900 defines a light receiving engine for processing and decoding optical messages.

Device 900 includes first module 910 and second module 920. Modules 910 and 920 can be hardware, software or a combination of hardware and software (i.e., firmware). Further, each of modules 910 and 920 can define one or more independent processor circuits or may comprise additional sub-modules. In an exemplary embodiment, at least one of modules 910 or 920 includes a processor circuitry and a memory circuitry in communication with each other. In another embodiment, modules 910 and 920 define different parts of the same data processing circuit.

In an exemplary embodiment, device 900 can be configured to receive an incoming optical signal and output digital data stream or display the communicated error in natural language. Module 910 can be configured to convert light into a first bit stream by directly receiving the incoming optical messages. Alternatively, module 910 can receive a sampled signal representing the incoming optical signal. In one embodiment, the output of module 910 is a digital data stream containing the incoming optical message.

Module 920 can receive the output of module 910, process and decode the message. Similar to module 910, module 920 can define firmware, applet, software or hardware. Module 920 can further process the digital data stream to obtain a digital signal corresponding to the encoded optical signal contained in each of the plurality of received optical frames. Module 920 can also decode the digital signal to obtain decoded information. Finally, module 920 can display (or caused to be displayed) the decoded information. Module 920 may also transmit the decoded information to an external device for further processing or store for future reference.

The following examples pertain to further embodiments of the disclosure. Example 1 includes a method for decoding an optical signal communication. The method comprising: receiving, at a device, a plurality of optical frames, each optical frame having an encoded optical signal with an optical signal frequency; recording the plurality of optical frames to obtain a recorded optical image, the recorded optical image having a first frame per second (FPS) recording rate; processing the recorded optical to obtain a digital signal corresponding to the encoded optical signal contained in at least one of the plurality of optical frames; and decoding the digital signal to obtain decoded information.

Example 2 includes e method of example 1, further comprising displaying the decoded message.

Example 3 includes the method of example 1, wherein the optical signal frequency defines a variable optical signal frequency and the first FPS define constant rate.

Example 4 includes the method of example 1, wherein processing the recorded optical image further comprises searching through the plurality of recorded frames sequentially or non-sequentially.

Example 5 includes the method of example 1, wherein processing e recorded optical image further comprises sampling each recorded frame at a sampling rate.

Example 6 includes the method of example 1, further comprising detecting a start-frame delimiter (SFD) packet to synchronize the device with the optical signal.

Example 7 includes the method of example 6, wherein at least portion of the SFD includes a varying optical signal amplitude.

Example 8 includes the method of example 1, wherein the digital signal defines a bit rate equal or greater than the first FPS.

Example 9 is directed to an apparatus for decoding optical communication. The apparatus comprises: a first module configured to receive a plurality of optical frames, each frame having an encoded optical signal with an optical signal frequency, the first module further configured to record the plurality of optical frames as recorded optical images having a first frame per second (fps); a second module configured to process the recorded optical images to obtain a digital data signal corresponding to the encoded optical signal contained in each or the plurality of the optical frames.

Example 10 includes the apparatus of example 9, wherein the first module is configured to communicate with a memory modulo to record the received plurality of optical frames.

Example 11 includes the apparatus of example 9, wherein the optical signal frequency defines a variable optical signal frequency and the first FPS defines a constant rate.

Example 12 includes the apparatus of example 9, wherein the second module is further configured to retrieve the recorded optical image and process the recorded optical image by searching through the plurality of recorded frames sequentially or non-sequentially.

Example 13 includes the apparatus of example 9, wherein the second module is further configured to process the recorded optical images by sampling each recorded frame at a sampling rate.

Example 14 includes the apparatus of example 9, wherein one of the first or the second module is further configured to detect a start-frame delimiter (SFD) packet synchronize the device with the optical signal.

Example 15 includes the apparatus example 14, wherein at least a portion of the SFD includes a varying optical signal amplitude.

Example 16 is directed to a system for decoding optical communication, comprising: an optical receiver to receive a plurality of optical frames, each optical frame having an encoded optical signal with an optical signal frequency; a memory circuit; a processor in communication with the memory circuit, the processor configured to store the plurality of optical frames as a recorded optical image having a first frame rate (fps), the processor further configured to process the plurality of optical frames to obtain as digital data signal corresponding the encoded optical signal contained at least one of the plurality of optical frames.

Example 17 is directed to the system of example 16, further comprising a digital decoder configured to receive and decode the digital data signal to provide a message encoded in the optical signal.

Example 18 is directed to the system of example 16, wherein the optical signal frequency defines a variable optical signal frequency and the FPS defines a constant rate.

Example 19 is directed to the system of example 16, wherein the processor is further configured to retrieve the recorded optical image and process the recorded optical image by searching through the plurality of frames sequentially or non-sequentially.

Example 20 is directed to the system of example 16, wherein the processor is further configured to process the recorded optical images by sampling each recorded frame at a sampling rate.

Example 21 is directed to a computer-readable storage device containing a set of instructions to cause a computer to perform a process comprising: receive a plurality of optical frames, each optical frame having an encoded optical signal with an optical signal frequency; record the plurality of optical frames to obtain a recorded optical image, the recorded optical image having a first frame per second (FPS) recording rate; and process the recorded optical image to obtain a digital signal corresponding to the encoded optical signal contained in at least one of the plurality of optical frames.

Example 22 is directed to the computer-readable storage device of example 21, wherein the storage device further comprises instructions to cause the processor to decode the digital signal to obtain decoded information.

Example 23 is directed to the computer-readable storage device of example 21, wherein the storage device further comprises instructions to cause the processor to search through the plurality of recorded optical frames sequentially or non-sequentially.

Example 24 is directed to the computer-readable storage device of example 21, wherein the storage device further comprises instructions to cause the processor to record the incoming optical images at a constant FPS and sample the recorded images at a variable sampling rate.

Example 25 is directed to the computer-readable storage device of example 21, wherein the storage device further comprises instructions to cause the processor to sample each recorded frame at a sampling rate.

While the principles of the disclosure have been illustrated in relation to the exemplary embodiments shown herein, the principles of the disclosure are not limited thereto and include any modification, variation or permutation thereof.

What is claimed is:

1. A method for decoding an optical signal communication, the method comprising:
receiving, at a device, a plurality of optical frames, each optical frame having an encoded optical signal with an optical signal frequency;
recording the plurality of optical frames to obtain a recorded optical image, the recorded optical image having a first frame per second (FPS) recording rate;
processing the recorded optical image to obtain a digital signal corresponding to the encoded optical signal contained in at least one of the plurality of optical frames; and
decoding the digital signal to obtain decoded information.

2. The method of claim 1, further comprising displaying the decoded message.

3. The method of claim 1, wherein the optical signal frequency defines a variable optical signal frequency and the first FPS defines a constant rate.

4. The method of claim 1, wherein processing the recorded optical image further comprises searching through the plurality of recorded frames sequentially or non-sequentially.

5. The method of claim 1, wherein processing the recorded optical image further comprises sampling each recorded frame at a sampling rate.

6. The method of claim 1, further comprising detecting, a start-frame delimiter (SFD) packet to synchronize the device with the optical signal.

7. The method of claim 6, wherein at least a portion of the SFD includes a varying optical signal amplitude.

8. The method of claim 1, wherein the digital signal defines a bit rate equal or greater than the first FPS.

9. An apparatus for decoding optical communication, comprising:
a first module configured to receive a plurality of optical frames, each frame having an encoded optical signal with an optical signal frequency, the first module further configured to record the plurality of optical frames as recorded optical images having a first frame per second (fps);
a second module configured to process the recorded optical images to obtain a digital data signal corresponding to the encoded optical signal contained in each of the plurality of the optical frames.

10. The apparatus of claim 9, wherein the first module is configured to communicate with a memory module to record the received plurality of optical frames.

11. The apparatus of claim 9, wherein the optical signal frequency defines a variable optical signal frequency and the first FPS defines a constant rate.

12. The apparatus of claim 9, wherein the second module is further configured to retrieve the recorded optical image and process the recorded optical image by searching through the plurality of recorded frames sequentially or non-sequentially.

13. The apparatus of claim 9, wherein the second module is further configured to process the recorded optical images by sampling each recorded frame at a sampling rate.

14. The apparatus of claim 9, wherein one of the first or the second module is further configured to detect a start-frame delimiter (SFD) packet to synchronize the device with the optical signal.

15. The apparatus of claim 14, wherein at least a portion of the SFD includes a varying optical signal amplitude.

16. A system for decoding optical communication, comprising:
an optical receiver to receive a plurality of optical frames, each optical frame having an encoded optical signal with an optical signal frequency;
a memory circuit;
a processor in communication with the memory circuit, the processor configured to store the plurality of optical frames as a recorded optical image having a first frame rate (fps), the processor further configured to process the plurality of optical frames to obtain a digital data signal corresponding the encoded optical signal contained at least one of the plurality of optical frames.

17. The system of claim 16, further comprising a digital decoder configure to receive and decode the digital data signal to provide message encoded in the optical signal.

18. The system of claim 16, wherein the optical signal frequency defines a variable optical signal frequency and the FPS defines constant rate.

19. The system of claim 16, wherein the processor is further configured to retrieve the recorded optical image and process the recorded optical image by searching through the plurality of frames sequentially or non-sequentially.

20. The system of claim 16, wherein the processor is further configured to process the recorded optical images by sampling each recorded frame at a sampling rate.

21. A computer-readable storage device containing a set of instructions to cause a computer to perform a process comprising:
receive a plurality of optical frames, each optical frame having an encoded optical signal with an optical signal frequency;
record the plurality of optical frames to obtain a recorded optical image, the recorded optical image having a first frame per second (FPS) recording rate; and
process the recorded optical image to obtain a digital signal corresponding to the encoded optical signal contained in at least one of the plurality of optical frames.

22. The computer-readable storage device of claim 21, wherein the storage device further comprises instructions to cause the processor to decode the digital signal to obtain decoded information.

23. The computer-readable storage device of claim 21, wherein the storage device further comprises instructions to cause the processor to search through the plurality of recorded optical frames sequentially or non-sequentially.

24. The computer-readable storage device of claim 21, wherein the storage device further comprises instructions to cause the processor to record the incoming optical images at a constant FPS and sample the recorded images at a variable sampling rate.

25. The computer-readable storage device of claim 21, wherein the storage device further comprises instructions to cause the processor to sample each recorded frame at a sampling rate.
